(19) United States
(12) Patent Application Publication
(10) Pub. No.: US 2009/0152026 A1
(43) Pub. Date: Jun. 18, 2009

(54) Mulch Distribution Device and Process

(76) Inventors: James E. Hawkinson, Jacksonville, FL (US); Robert N. Hawkinson, Jacksonville, FL (US)

Correspondence Address: LAW OFFICE OF L. JACK GIBNEY, 8777 SAN JOSE BLVD., SUITE 502, JACKSONVILLE, FL, 32217, US

(21) Appl. No.: 11/957,551

(22) Filed: Dec. 17, 2007

(51) Int. Cl. B60P 3/00

(52) U.S. Cl. 180/65.1; 180/89.11

(57) ABSTRACT

This invention allows for the even distribution of mulch with minimal human effort. Mulch distribution is common with today's homeowner and business owner and will provide a certain aesthetic appeal to the vegetation of a flower bed or the curb appeal of a building. The primary difficulty with mulch distribution is getting the mulch to the site. This device will consist of a dolly, which will enable the user to load a desired quantity of mulch from a central loading site and then transport the mulch easily to the desired area and allow the individual to distribute the mulch evenly. This device can be filled remotely with a mulch truck so that the individual homeowner or business owner does not have to physically lift great amounts of mulch over long periods of time in order to put them on flower beds or around other areas of vegetation.

### BACKGROUND OF THE INVENTION

A. Field of the Invention

This relates to mulching yards and a method to distribute mulch. The device is a way to distribute mulch in a much, simpler manner than is currently employed and also seek to place treated mulch to retard the spread of fungus and rot in the mulch.

B. Prior Art

There are other prior art references to mulch and distribution devices not necessarily related to mulch but distribution devices in general. A prior art reference for a mulch distribution device is found in Muller, U.S. Pat. No. 4,335,897. Another wheeled tool carrier can be found in Maxwell, U.S. Pat. No. 6,179,306. These devices are distribution devices in general in terms of garden carts, which obviously can be used for mulching purposes. However, they do not have a similar structure as the current device. This cart will also allow the user to carry multiple cans from a central mulch loading station to the site to be mulched.

### BRIEF SUMMARY OF THE INVENTION

This is a device and a method to enable an individual to collect mulch from a mulching truck into containers and then easily transport that mulch to the area to be covered. The containers are transported to the particular bed that is to be mulched and the mulch is evenly distributed by the individual. This reduces the amount of labor involved and allows the user to carry a much greater quantity of mulch from the central loading station to the area to be mulched.

Currently, mulch is simply dropped in a heap or pile on a sidewalk or portion of the lawn. The homeowner must then use a shovel or pitchfork to manually carry portions of mulch to and from the mulch pile to the designated area. A wheelbarrow may be used in this operation but the mulch is still physically lifted from the ground to the mulch bed via the wheelbarrow. This can be very stressful on the person's back and can produce, by the very nature of the operation, unevenness because different amounts of mulch are transported to particular sites and fatigue besets the person distributing the mulch; this unevenness may also result in waste. This unevenness may ultimately detract from the curb appeal of any house or building.

This device allows for a more even distribution of the mulch in the bed because the same general quantity is transported to a particular site because equal sized containers are used with the device; this results in a consistent look for the homeowner. This device also allows the material to be rolled, shaken or thrown out, depending on what part of the bed is being mulched and greatly eliminates the strain on the person's back.

### BRIEF DESCRIPTION OF THE DRAWINGS

FIG. 1 is an isometric view of the device with the cans depicted with dashed lines.

FIG. 2 is an isometric view of the device from the handle, again with the cans depicted with dashed lines.

FIG. 3 is a side view of the device with the cans depicted with dashed lines.

FIG. 4 is a front view of the device.

FIG. 5 is a view from the back of the device.

FIG. 6 is a side view of the device.

FIG. 7 is a bottom view of the device.

FIG. 8 is a top view of the device.

FIG. 9 is a view depicting the means of power transmission.

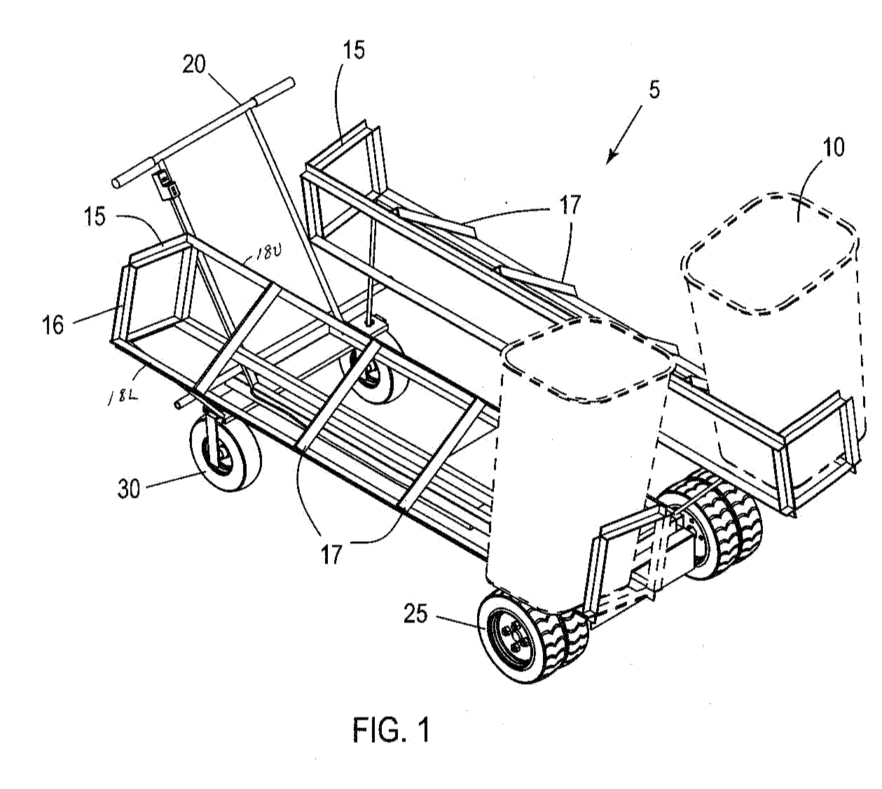

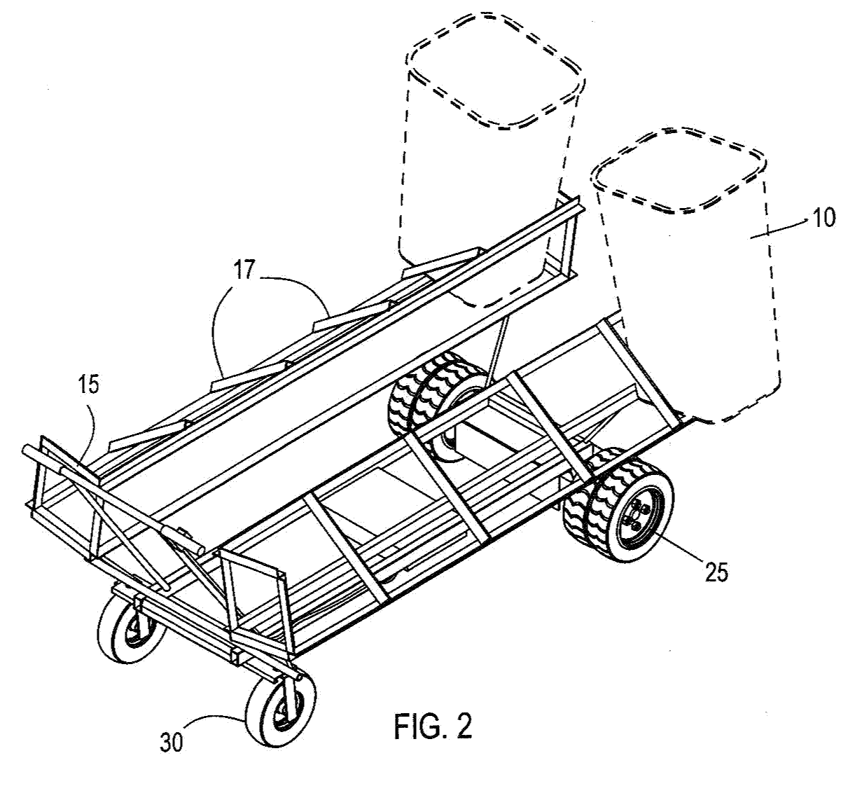

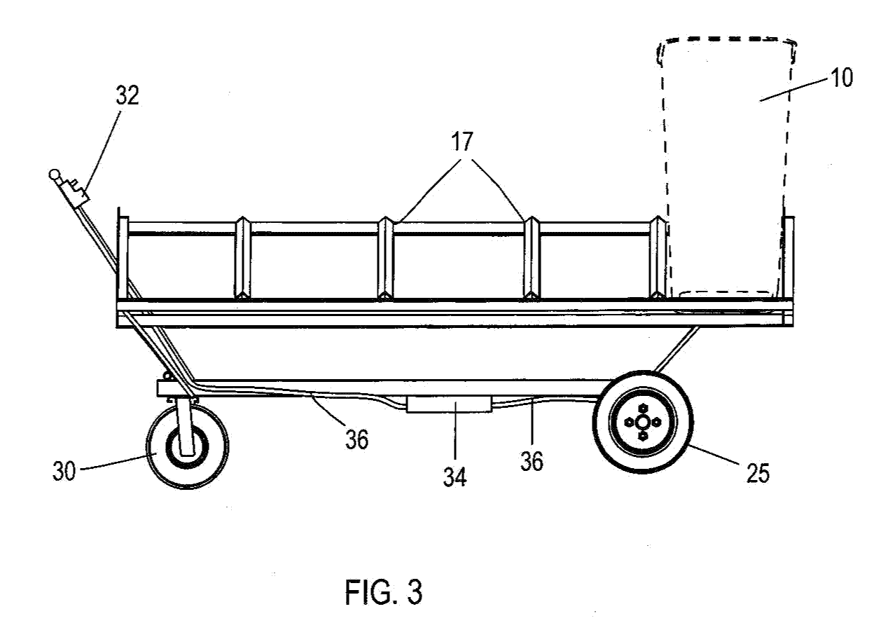

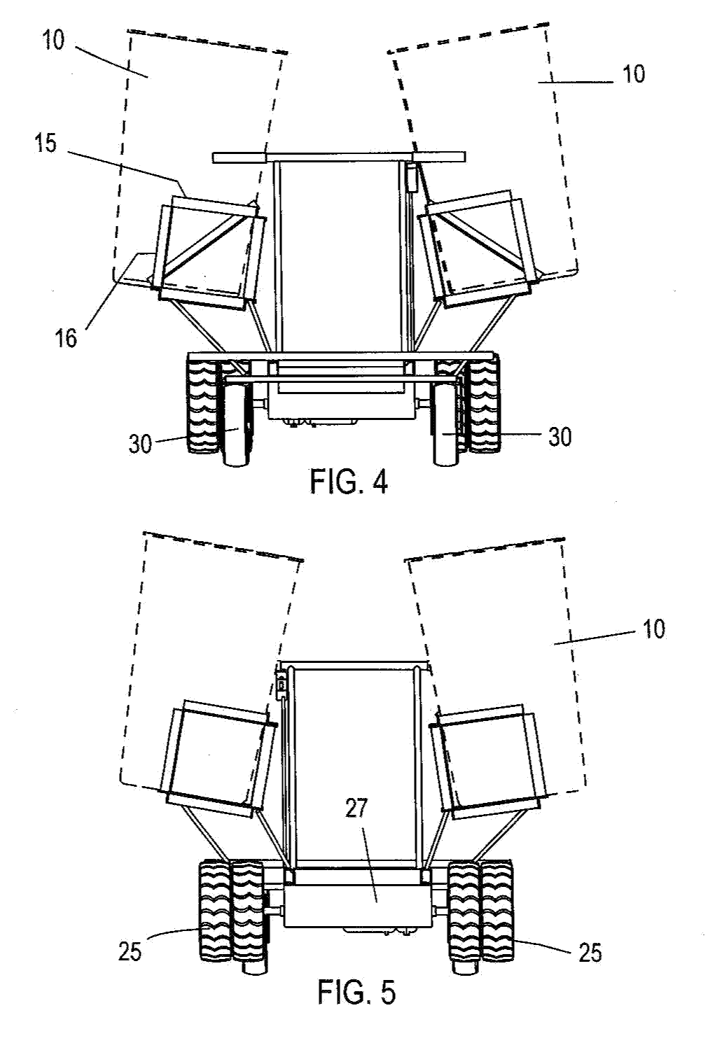

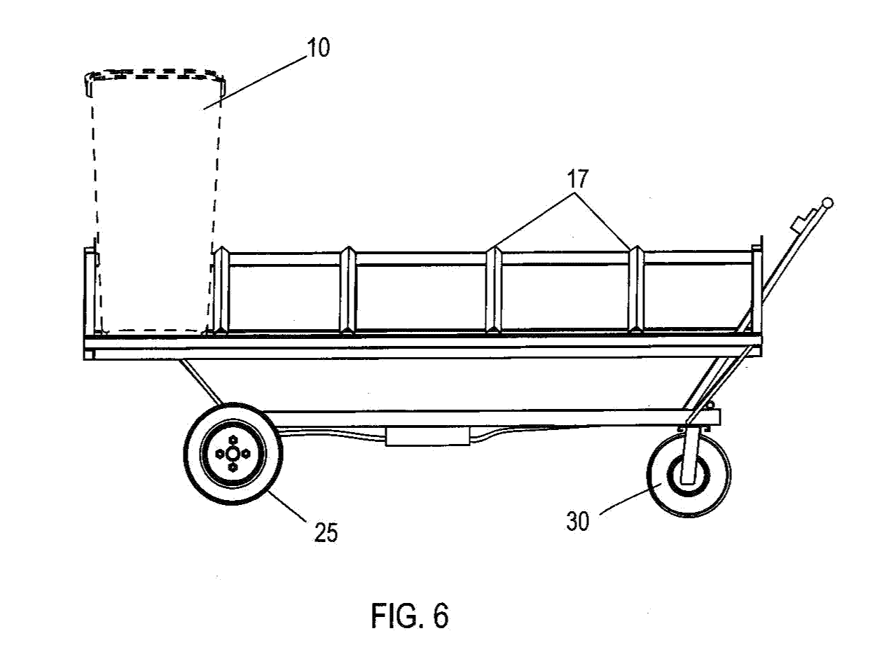

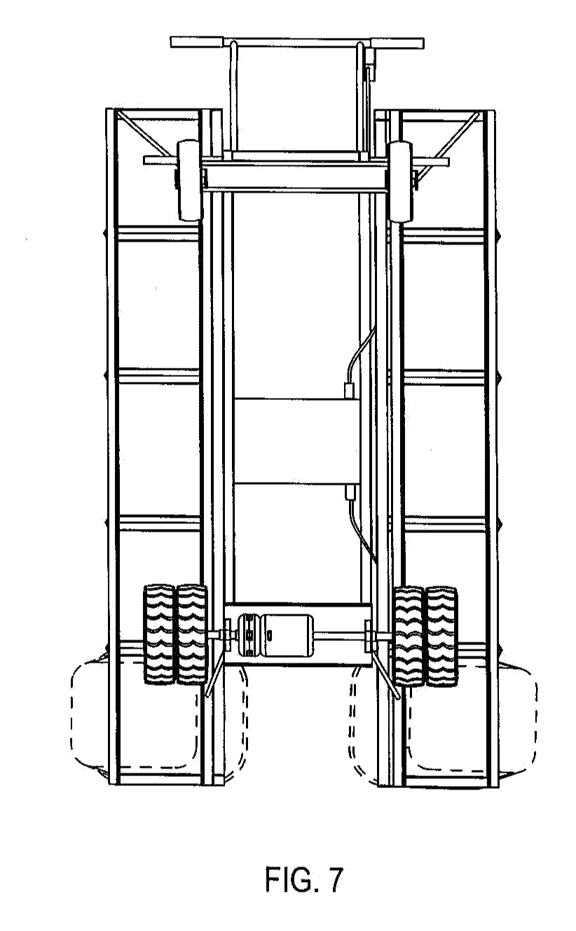

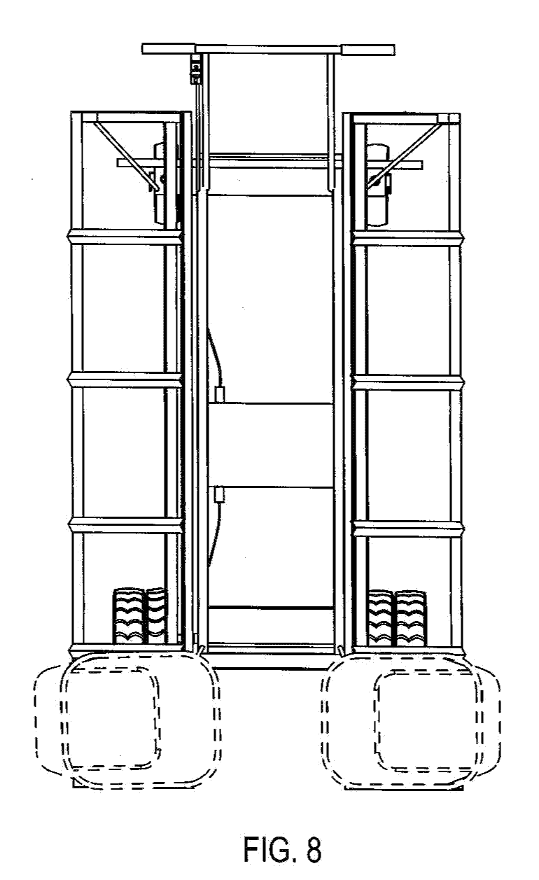

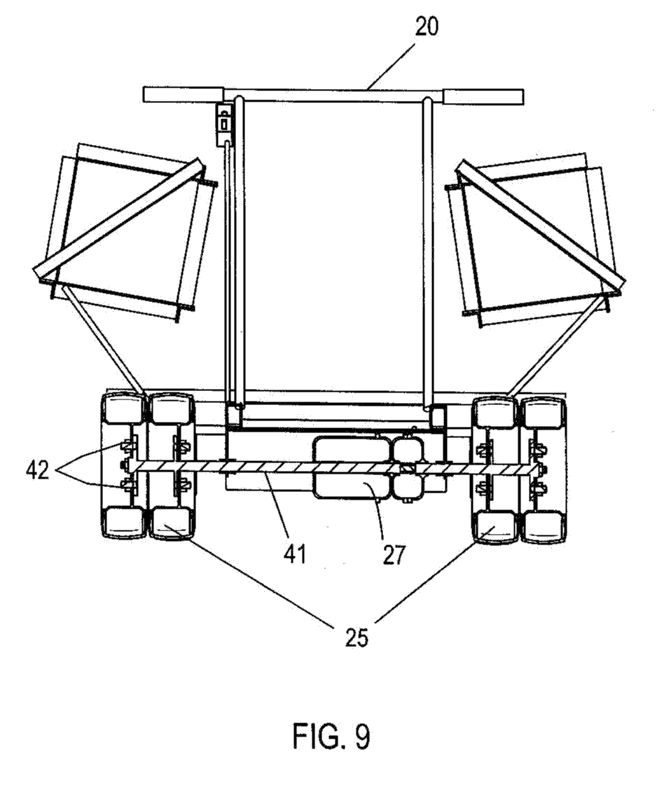

### DETAILED DESCRIPTION OF THE EMBODIMENTS

This device 5 is a mulch distribution device which will enable a more even distribution of mulch in a bed. The device will be comprised of one or more rows of frame members that will support a plurality of containers into which mulch is inserted on a portable dolly system. The dolly system will allow an individual to quickly and easily fill the empty containers and then allow the containers to be moved to the appropriate mulching site without having to lift or scoop the mulch into a wheelbarrow or lift the container over a rail.

Each container is separate and carried at a height that minimizes lifting and rests at an angle relative to the frame of the dolly; each container can be lifted separately from the dolly assembly, if needed. This will allow an individual to be able to distribute the mulch without necessarily lifting a great deal of weight over a long period of time.

The mulch is distributed by simply tilting or sliding the individual container, shaking, rolling or throwing out the mulch depending on which area of the bed is being covered and the desired thickness can be adjusted easily. Because the physical steps of moving a quantity of mulch from place to place have been greatly reduced or eliminated this device helps to reduce strain on the person's body and the desired look of the bed can be achieved with minimal effort.

The containers that are used to carry the mulch may have a funnel lip to assist in even distribution. The container may also be square to reduce spillage between containers when filling. Different sized containers may also be used. The containers may be filled at a central loading station such as a mulch truck while the containers are positioned on the dolly 5 and then transported to the place onto which the mulch will be distributed. This eliminates the step of having the person load the container while on the dolly and then transporting it to the mulch site.

The dolly 5 that serves as the frame to carry a plurality of containers will be powered and will rest on a set of wheels 25, 30 that support the weight of the frame of the dolly. The handle 20 will be on one end and will be used to direct or steer this particular dolly as it is being moved through different environments.

When the device is used, a set of containers 10 will be placed on the frame of the dolly. Two sets of frame members on which to hold containers 10 will be provided on either side of the centerline of the device. Frame members 15, 16, 18L and 18U will form the frame onto which the containers 10 will rest. The long horizontal members 18L (lower) and 18U (upper) will extend from the handle 20 to the power transmission area of the device. A plurality of dividing members 17 will be secured at one end at the lower long horizontal member 18L and at the other end at the upper long horizontal member 18U. Horizontal frame member 15 and vertical frame member 16 will provide an end piece on which the containers may rest if placed on one of the end areas of the device. The structure on which the containers will rest is tilted slightly inward to prevent the containers from falling out during normal transport.

Each side of the frame will support a plurality of containers 10 that hold the mulch. The frame members 16 will have a certain predetermined shape that will be positioned slightly inward so that the container is positioned on the frame members and will rest at an angle to ensure that the containers with the loaded mulch do not inadvertently fall from the device.

On the frame structure will be a series of dividing members 17, which are slightly greatly than the width of the container. The dividing members 17 will separate the container from each other while on the frame and also provide support for the long horizontal support members 18L, 18U. Dividing members 17 will be placed on both sides of the frame or support members.

A set of rear wheels 25 on the device are provided to support the weight of the frame and the weight of the container when loaded and to transfer the power from the power transmission device to the device. Additionally, the rear wheels 25 are connected by one axle 41 to the power transmission device 27. The power mechanism 27 will be placed in a structure to protect the inner components. The power transmission device 27 is likely to be a small electric motor powered by a plurality of batteries but may also be powered by alternating current.

The appropriate electrical connections between the switch 32 at the front near the handle 20 will be provided to provide power to the power transmission device that will power the wheels. This powering system will allow the device to be easily maneuvered without much effort on the part of the operator and will enable a large quantity of mulch to be transported from the central mulching drop-off area to the bed that will eventually be mulched.

The outside wheels 25 will be connected, using a lug nut arrangement, which is commonly used today.

The handle 20 of the device will be long enough to extend and allow sufficient area by which an individual container maneuver this particular mulch distribution device over sometimes irregular terrain.

A front pair of wheels 30 will be placed on the front of the device near the handle. These wheels 20 will be allowed to swivel so that maneuvering will not be difficult or will be made easy specifically by this set of wheels.

The choice of the type of wheel will be dictated by the environment. The wheels need to be able to support the weight of the dolly as well as the contents of the mulch containers, which will be placed on the support members themselves. The wheels may be pneumatic wheels or solid core rubber wheels.

While the embodiments of the invention have been disclosed, certain modifications may be made by those skilled in the art to modify the invention without departing from the spirit of the invention.

The inventor claims:

1. A mulch distribution device, which is comprised of:
a. a frame structure;
wherein the frame structure is of a predetermined shape;
wherein a plurality of long horizontal support members are positioned on the frame structure;
said long horizontal support members extend from the handle to the power transmission area of the frame;
wherein a vertical support member is provided at the respective ends of the structure;
said vertical support member is attached to a short horizontal support member at the first end;
wherein a short horizontal support member is provided;
wherein said frame members tilt slightly inward;
wherein a plurality of divider members are placed along the frame members between an upper horizontal member and a lower horizontal member;
said divider members are slightly larger than the width of mulch cans;
b. containers;
wherein the containers are of predetermined shape;
wherein the containers hold a predetermined quantity of mulch;
wherein a plurality of containers are positioned on the support members;
wherein said mulch containers tilt slightly inward on the device;
c. front wheels;
wherein front wheels support the weight of the device;
wherein the front wheels swivel;
d. rear wheels;
wherein the rear wheels are connected to a power transmission means;
wherein the rear wheels support the weight of the device;
e. a handle;
wherein the handle is secured to the frame;
wherein the handle extends a predetermined length;
wherein a power switch is positioned close to the area of the handle;
wherein the power switch operates the power transmission mechanism;
f. power source;
g. power transmission device;
wherein a power transmission device is provided.

2. The device as described in claim 1 wherein the front wheels are compromised of two sets of wheels on either side of the support frame.

3. The device as described in claim 1 wherein the wheels are pneumatic.

4. The device as described in claim 1 wherein the two rear wheels on each side is used.

5. The device as described in claim 1 wherein a set of gears operates the power transmission device.

6. The device as described in claim 1 wherein the power source is a plurality of batteries.

7. The device as described in claim 1 wherein the power source is alternating current.
